(19) United States
(12) Patent Application Publication
(10) Pub. No.: US 2013/0067392 A1
(43) Pub. Date: Mar. 14, 2013

(54) Multi-Input Rearrange

(71) Applicants: Chantal M. Leonard, Seattle, WA (US); Rebecca Deutsch, Seattle, WA (US); John C. Whytock, Portland, OR (US); Jan-Kristian Markiewicz, Redmond, WA (US)

(72) Inventors: Chantal M. Leonard, Seattle, WA (US); Rebecca Deutsch, Seattle, WA (US); John C. Whytock, Portland, OR (US); Jan-Kristian Markiewicz, Redmond, WA (US)

(73) Assignee: Microsoft Corporation, Redmond, WA (US)

(21) Appl. No.: 13/229,952

(22) Filed: Sep. 12, 2011

(51) Int. Cl. G06F 3/048

(52) U.S. Cl. 715/784; 715/781

(57) ABSTRACT

Multi-input rearrange techniques are described in which multiple inputs are used to rearrange items within navigable content of a computing device. Objects can be selected by first input, which causes the objects to remain visually available within a viewing pane as content is navigated through the viewing pane. In other words, objects are “picked-up” and held within the visible region of a user interface as long as the first input continues. Additional input to navigate content can be used to rearrange selected objects, such as by moving the object to a different file folder, attaching the objects to a message, and so forth. In one approach, one hand can be used for a first gesture to pick-up an object and another hand can be used for gestures/input to navigate content while the picked-up object is being “held” by continued application of the first gesture.

### BACKGROUND

One of the challenges that continues to face designers of devices having user-engageable displays, such as touch displays, pertains to providing enhanced functionality for users, through gestures that can be employed with the devices. This is so, not only with devices having larger or multiple screens, but also in the context of devices having a smaller footprint, such as tablet PCs, hand-held devices, smaller multi-screen devices and the like.

One challenge with gesture-based input is that of providing rearrange actions. For example, in touch interfaces today, a navigable surface typically reacts to a finger drag and moves the content (pans or scrolls) in the direction of the user's finger. If the surface contains objects that a user might want to rearrange, it is difficult to differentiate when the user wants to pan the surface or rearrange the content. Moreover, a user may drag objects across the surface to move the objects, which initiates content navigation by auto-scroll when the objects are dragged proximate to a boundary of the viewable content area within a user interface. This object initiated auto-scroll approach to navigation can be visually confusing and can limit the navigation actions available to a user while dragging selected objects.

### SUMMARY

Multi-input rearrange techniques are described in which multiple inputs are used to rearrange items within navigable content. A variety of suitable combinations of gestures and/or other input can be employed to “pick-up” objects presented in a user interface and navigate to different locations within navigable content to rearrange selected objects. The inputs can be configured as different gestures applied to a touchscreen including but not limited to gestural input from different hands. One or more objects can be picked-up via first input and content navigation can occur via second input. The one or more objects may remain visually available in the user interface during navigation by continued application of the first input. The objects may be rearranged at a target location when the first input is concluded.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing some components of FIG. 1 in greater detail.

FIG. 3 illustrates an example user interface in accordance with one or more embodiments.

FIG. 4 illustrates an example user interface in accordance with one or more embodiments.

FIG. 5 illustrates an example user interface in accordance with one or more embodiments.

FIG. 6 illustrates an example sequence for a multi-input rearrange in accordance with one or more embodiments.

FIG. 7 illustrates an example user interface in accordance with one or more embodiments.

FIG. 8 is a flow diagram that describes the steps of an example method in accordance with one or more embodiments.

FIG. 9 is a flow diagram that describes steps of another example method in accordance with one or more embodiments.

FIG. 10 illustrates an example computing device that can be utilized to implement various embodiments described herein.

### DETAILED DESCRIPTION

### Overview

Multi-input rearrange techniques are described in which multiple inputs are used to rearrange items within navigable content provided via a computing device. In one or more embodiments, multi-input rearrange gestures can mimic physical interaction with an object such as picking-up and holding an object. Selection of one or more objects causes the objects to remain visually available (e.g., visible) within a viewing pane of a user interface as content is navigated through the viewing pane. In other words, objects that are “picked-up” are held within the visible region of a user interface so long as a gesture to hold the object continues. Additional input to navigate content can therefore occur to rearrange selected objects that have been picked-up, such as by moving the objects, placing the objects into a different file folder, attaching the objects to a message, and so forth. In one approach, one hand can be used for a first gesture to pick-up an object while another hand can be used for gestures/input to navigate content while the picked-up object is being “held” by continued application of the first gesture.

In the following discussion, an example environment is first described that is operable to employ the multi-input rearrange techniques described herein. Example illustrations of gestures, user interfaces, and procedures are then described, which may be employed in the example environment, as well as in other environments. Accordingly, the example environment is not limited to performing the example gestures and the gestures are not limited to implementation in the example environment. Lastly, an example computing device is described that can be employed to implement techniques for multi-input rearrange in one or more embodiments.

Example Environment

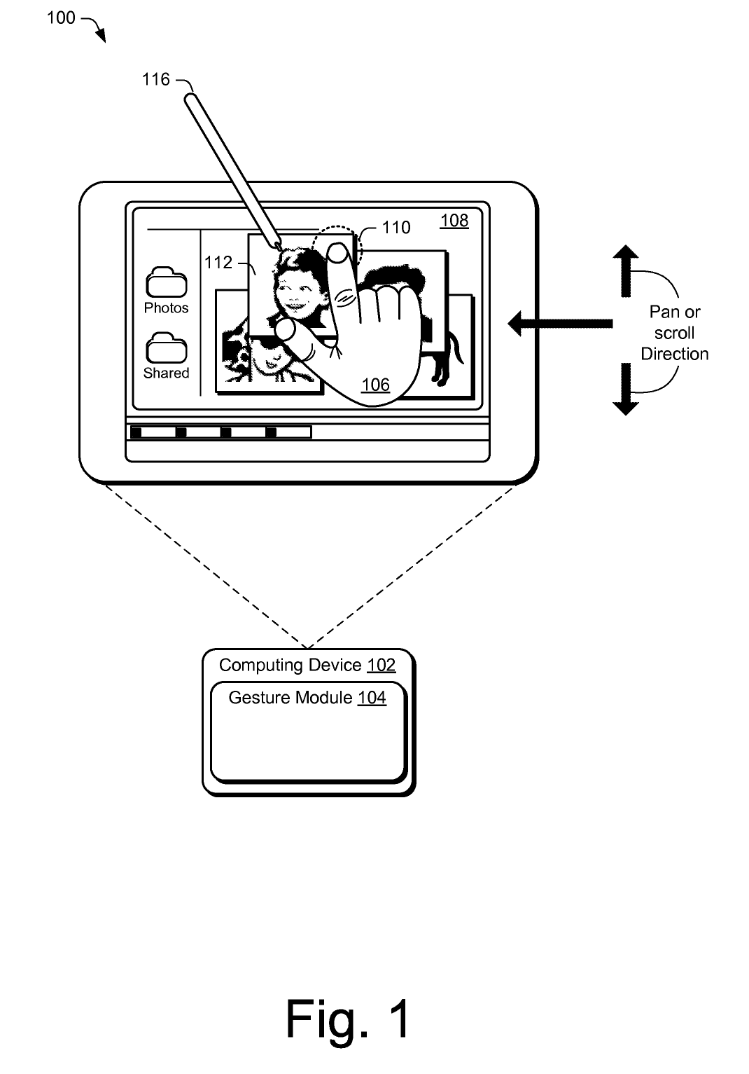

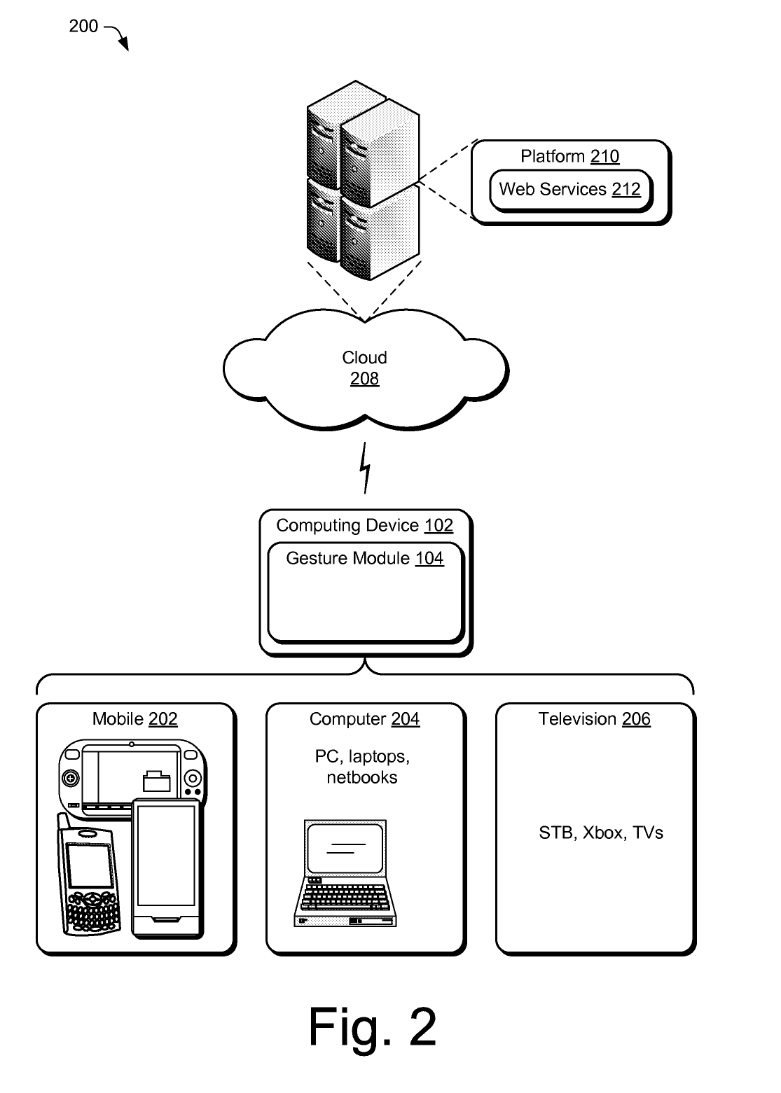

FIG. 1 is an illustration of an environment 100 in an example implementation that is operable to employ multi-input rearrange techniques as described herein. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

The computing device 102 includes a gesture module 104 that is operable to provide gesture functionality as described in this document. The gesture module can be implemented in connection with any suitable type of hardware, software, firmware or combination thereof. In at least some embodiments, the gesture module is implemented in software that resides on some form of computer-readable storage media examples of which are provided below.

The gesture module 104 is representative of functionality that recognizes gestures, including gestures that can be performed by one or more fingers, and causes operations to be performed that correspond to the gestures. The gestures may be recognized by the gesture module 104 in a variety of different ways. For example, the gesture module 104 may be configured to recognize a touch input, such as a finger of a user's hand 106 as proximal to display device 108 of the computing device 102 using touchscreen functionality. In particular, the gesture module 104 can recognize gestures that can be applied on navigable content that pans or scrolls in different directions, to enable additional actions, such as content selection, drag and drop operations, relocation, and the like. More over multiple, multi-touch, and multi-handed inputs can be recognized to cause various responsive actions.

For instance, in the illustrated example, a pan or scroll direction is shown as indicated by the arrows. In one or more embodiments, a selection gesture to select one or more objects can be performed in various ways. For example objects can be selected by a finger tap, a press and hold gesture, a grasping gesture, a pinching gesture, a lasso gesture, and so forth. In at least some embodiments, the gesture can mimic physical interaction with an object such as picking up and holding an object. Selection of the one or more objects causes the objects to remain visible within a viewing pane as content is navigated through the viewing pane. In other words, objects that are “picked-up” are held within the visible region of a user interface so long as a gesture to hold the object continues. In some instances, the user may continue to apply a gesture by continuing contact of the user's hand/fingers with the touchscreen. Additional input to navigate content can therefore occur to rearrange selected objects, such as by moving the objects, placing the objects into a different file folder, attaching the objects to a message, and so forth. In one approach, one hand is used for a gesture to pick-up an object while another hand is used for gestures to navigate content while the object is being picked-up.

In particular, a finger of the user's hand 106 is illustrated as selecting 110 an image 112 displayed by the display device 108. Selection 110 of the image 112 to pick-up an object may be recognized by the gesture module 104. Other movement of the user's hands/fingers to navigate content presented via the display device 108 may also be recognized by the gesture module 104. Navigation of content can include for example panning and scrolling of objects through a viewing pane, folder selection, application switching, and so forth. The gesture module 104 may identify recognized movements by the nature and character of the movement, such as continued contact to select one or more objects, swiping of the display with one or more fingers, touch at or near a folder, menu item selections, and so forth.

A variety of different types of gestures may be recognized by the gesture module 104 including, by way of example and not limitation, gestures that are recognized from a single type of input (e.g., touch gestures) as well as gestures involving multiple types of inputs. For example, module 104 can be utilized to recognize single-finger gestures and bezel gestures, multiple-finger/same-hand gestures and bezel gestures, and/or multiple-finger/different-hand gestures and bezel gestures.

Further, the computing device 102 may be configured to detect and differentiate between a touch input (e.g., provided by one or more fingers of the user's hand 106 and a stylus input (e.g., provided by a stylus 116). The differentiation may be performed in a variety of ways, such as by detecting an amount of the display device 108 that is contacted by the finger of the user's hand 106 versus an amount of the display device 108 that is contacted by the stylus 116.

Thus, a gesture module 104 may be implemented to support a variety of different gesture techniques through recognition and leverage of a division between different types of input including differentiation between stylus and touch inputs, as well as of different types of touch inputs. Moreover, various other kinds of inputs, for example inputs obtained through a mouse, touchpad, software or hardware keyboard, and/or hardware keys of a device (e.g., input devices), can be also used in combination with or in the alternative to touchscreen gestures to perform multi-input rearrange techniques described herein. As but one example, an object can be selected using touch input applied with one hand while another hand is used to operate a mouse or dedicated device navigation buttons (e.g., track pad, keyboard, direction keys) to navigate content to a destination location for the selected object.

A selected object is “picked-up” and accordingly remains visible on the display device throughout the content navigation, so long as the selection input persists. When input to select the object concludes, though, the object can be “dropped” and rearranged at a destination location. For instance, an object may be dropped when the finger of the user's hand 106 is lifted away from the touchscreen to conclude a press and hold gesture. Thus, recognition of the touch input/gestures that describe selection of the image, movement of displayed content to another location while the object remains visible, and then action to conclude selection of an object of the user's hand 106 may be used to implement a rearrange operation, as described in greater detail below.

FIG. 2 illustrates an example system showing the gesture module 104 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks. For example, the gesture module 104 may be implemented in part on the computing device 102 as well as via a platform 210 that supports web services 212.

For example, the gesture techniques supported by the gesture module may be detected using touchscreen functionality in the mobile configuration 202, track pad functionality of the computer 204 configuration, detected by a camera as part of support of a natural user interface (NUI) that does not involve contact with a specific input device, and so on. Further, performance of the operations to detect and recognize the inputs to identify a particular gesture may be distributed throughout the system 200, such as by the computing device 102 and/or the web services 212 supported by the platform 210 of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable media including various kinds of computer readable memory devices, storage devices, on other articles configured to store the program code. The features of the gesture techniques described below are platform-independent, meaning that the techniques may be implemented on a variety of commercial computing platforms having a variety of processors.

Example Multi-Input Rearrange Techniques

In one or more embodiments, a multi-input rearrange can be performed for rearranging an object by selecting an object with a first input and navigating content with a second input. As mentioned, the inputs can be different touch inputs including, but not limited to, input applied by different hands. Details regarding multi-input rearrange techniques are discussed in relation to the following example user interfaces that may be presented by way of a suitably configured device, such as the example computing devices of FIGS. 1 and 2.

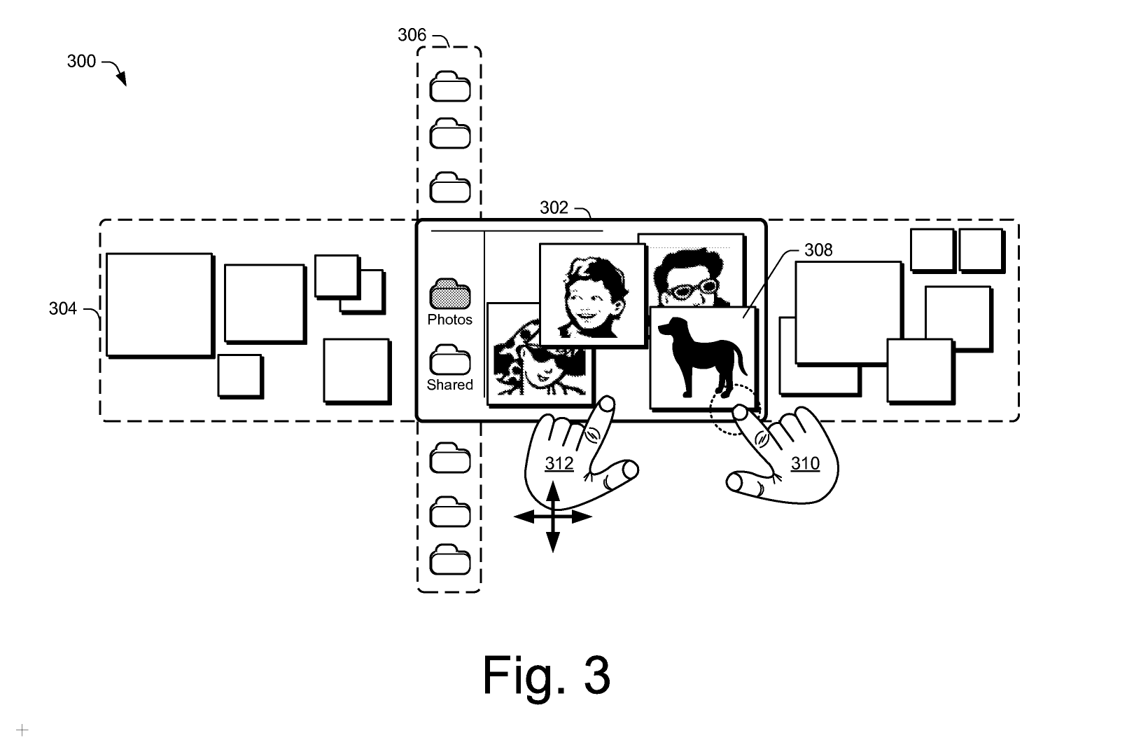

Consider FIG. 3 which illustrates an example user interface 300 in accordance with one or more embodiments. Here, a viewing pane 302 can be presented through which content can be navigated on a display device 108. Various navigation actions can be performed to manipulate the viewing pane 302 and thereby make different locations within the user interface visible and hidden along with corresponding objects. In the illustrated example content can be scrolled or panned in the horizontal direction, as indicated by the phantom box 304. Content can also be scrolled or panned in the vertical direction, as indicated by the phantom box 306. Other navigation actions may also be applied, such as menu selections, folder selections, navigational inputs provided using input devices like a mouse or keyboard, and so forth.

Various user interface objects such as folders, icons, media content, pictures, applications, application files, menus, webpages, text, and so forth can be represented and/or rendered within the viewing pane 302. Further, the user interface 300 and corresponding content can extend logically outside of the viewing pane 302 as represented by the phantom boxes 304 and 306. Generally, objects located at locations within the viewing pane are visible to a viewer while objects outside of the viewing pane are invisible or hidden. Accordingly, navigation of content rendered in the user interface through the viewing pane 302 can expose different objects at different times.

The example user interface 300 can be arranged in various different ways to present different types of content, collections, file systems, applications, documents, objects, and so forth. By way of example and not limitation, FIG. 3 depicts a photo collection presented such that the collection can be scrolled horizontally. Further, different file folders are illustrated to represent different file system locations and corresponding objects that are scrollable vertically.

As further depicted, an example object 308 illustrated as a photo of a dog has been selected and picked-up. This can occur in response to a first input 310, such as a user touching over the object on a touchscreen with their finger(s) or hand. Picking-up the object causes the object to remain displayed visibly within the viewing pane 302 as navigation of content through the pane occurs. The object remains displayed visibly so long as the user continues to apply the first input 310. The pick-up action can also be animated to make the selected object visually more prominent in any suitable way. This may include for example adding a border or shadow around the object 308, bringing the object to the front, expanding the object, and or otherwise making the selected object visually more prominent.

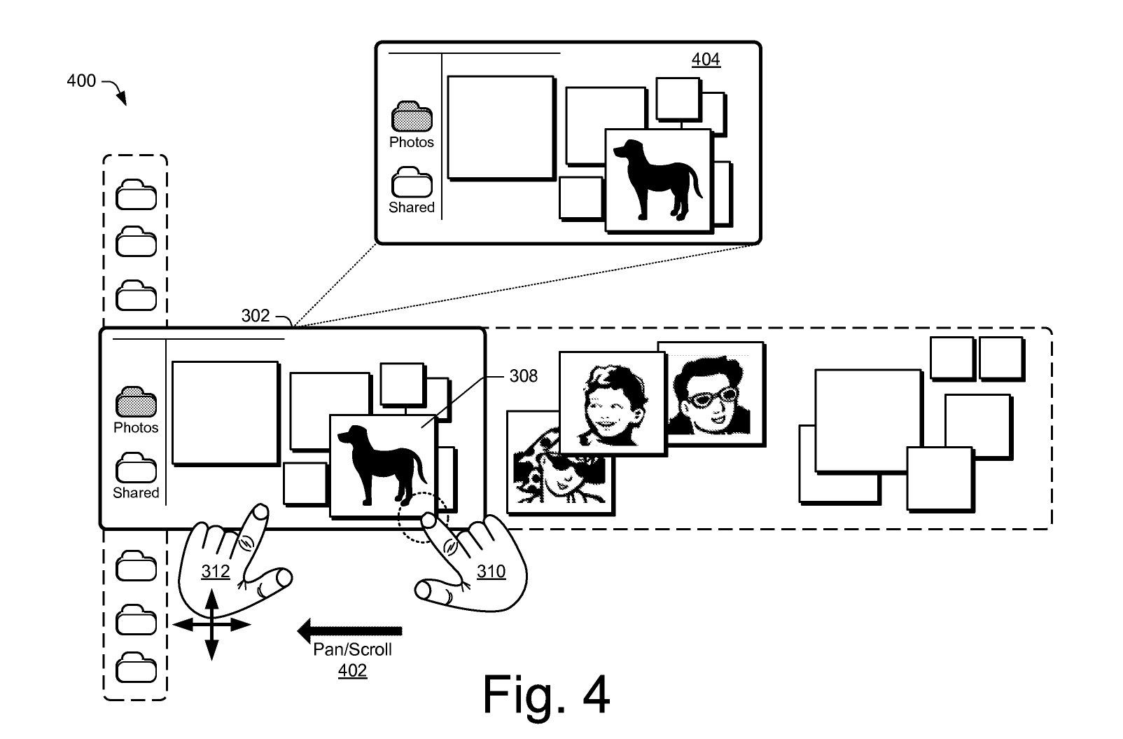

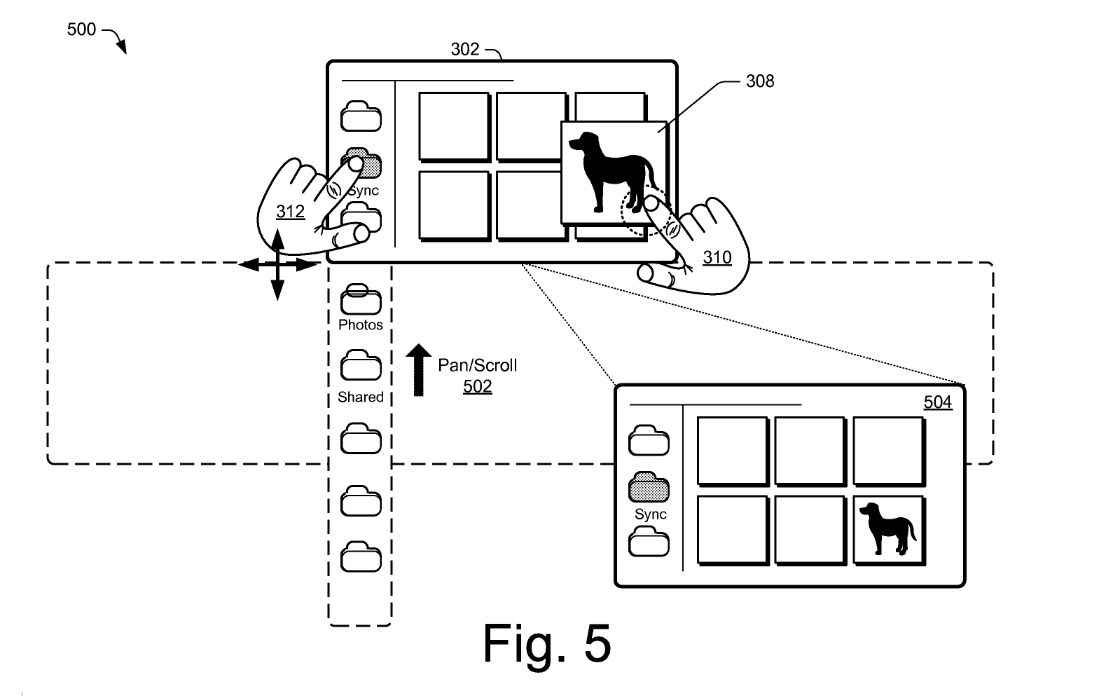

While the object 308 is picked-up, a user can affect scrolling or panning in the horizontal direction by a second input 312. For instance, the user may use their other hand to make a swiping gesture in the horizontal direction to navigate the example picture collection. Alternately, the user may make a swiping gesture in the vertical direction to navigate the different folders. Other gestures, input, and navigation actions to navigate content can also be applied via the user interface. Examples of manipulating the viewing pane 302 in the horizontal and vertical directions to display different locations of navigable content are depicted in relation to FIGS. 4 and 5 respectively, which are discussed in turn just below. Note that navigation can occur in many different directions as well as in multiple directions to rearrange an object depending on the particular configuration of the user interface.

In particular, FIG. 4 illustrates an example of content navigation to rearrange an object in accordance with one or more embodiments, generally at 400. Here, navigation 402 to pan or scroll the viewing pane 302 in the horizontal direction is illustrated as being caused by the second input 312 of FIG. 3. Accordingly, the viewing pane is logically relocated to the left in FIG. 4 to represent that a different content location and corresponding objects are now visible through the viewing pane. Other objects, such as the example photos of people, have been navigated out of the visible area of the viewing pane and therefore have become hidden from view. During the navigation, the selected object 308 remains visually available. In other words, the selected object stays connected with the movement of the viewing pane 302 and is held in a visible position by continuation of the first input 310 to pick-up the object.

When the first input 310 concludes, the picked-up object 308 can be released and rearranged at a destination location selected through the navigation. The release and rearrangement of the object can also be animated in various ways using different rearrangement animations. For example, the object can sweep or shrink into position, border effects applied upon pick-up can be removed, other objects can appear to reposition around the rearranged object, and so forth. Here the example dog photo can be released by the user lifting their finger to conclude the first input 310. This causes the example dog photo to be rearranged within the example photo collection at a destination position at which the viewing pane 302 is now located. A rearranged view 404 is depicted that represents the rearrangement of the object 308 at the destination position using the described multi-input rearrange techniques.

FIG. 5 illustrates another example rearrangement of an object 308 that is picked-up in accordance with one or more embodiments, generally at 500. In this example, navigation 502 to pan or scroll the viewing pane 302 in the vertical direction is illustrated as being caused by the second input 312 of FIG. 3. This can occur for instance to navigate and select different file system folders and/or locations for the selected object 308. In particular, the example dog photo is depicted as being selected and rearranged from a “photo” folder for the collection to a “sync” folder that represents a folder that may automatically sync to an online service and/or corresponding storage location. As in the preceding example, the selected object 308 remains visible during the navigation through continuation of the first input 310. When released, by the user lifting their finger or otherwise, the example dog photo is rearranged at the destination position within the sync folder to which the viewing pane 302 has been navigated. Another rearranged view 504 is depicted that represents the rearrangement of the object 308 at the destination position using the described multi-input rearrange techniques.

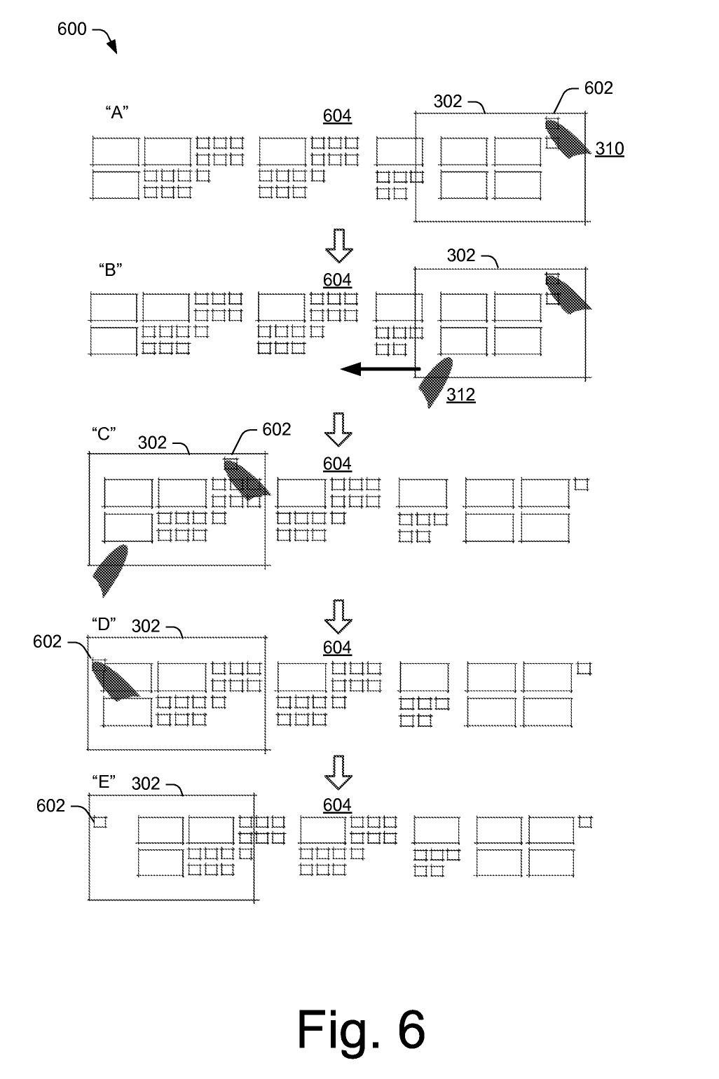

FIG. 6 shows an example scenario 600 representing a sequence of operations that can occur for a multi-input rearrangement of one or more objects 602. The one or more objects 602 may be arranged at different locations within navigable content 604 that is rendered for display at a computing device 102. In the example scenario, a viewing pane 302 is depicted that enables navigation, selection, and viewing of the different locations within the navigable content 604. The navigable content 604 can be presented within a user interface for a device, operating system, particular application, and so forth. Additionally or alternatively, the navigable content 604 content can include network based content such as webpages and/or services accessed over a network using a browser or other network enabled application. Generally, the navigable content 604 can be panned, scrolled, or otherwise manipulated by applied navigation actions to show different portions of content through the viewing pane 604 at different times. One or more objects 602 of the content can be selected and rearranged according to multi-input rearrange techniques described herein. Example operations that occur to perform such a rearrangement are denoted in FIG. 6 by different letters.

At “A”, an object 602 within the viewing pane 302 is selected by first input 310, such as a touch gesture applied to the object 602. For example, a user can press and hold over the object using a first hand or finger. At “B”, the viewing pane 302 is manipulated to navigate within the navigable content 604. For instance, the user may use a second hand or a finger of the second hand to swipe the touchscreen thereby scrolling content through the viewing pane 302 as represented by the arrow indicating scrolling to the left. While manipulating the viewing pane 302, the user may continue to apply the first input to the object (e.g., press and hold), which keeps the object 602 at a visible position within the viewing pane 302 as the user navigates the navigable content 604. At “C”, the viewing pane 302 has been manipulated to scroll to the left and a different portion of the navigable content 604 is now visible in the viewing pane 302. Note that the picked-up object also remains visible in the viewing pane 302.

The user can conclude the navigation of content and select a destination by discontinuing the second input 312 as shown at “D”. Naturally, multiple navigation actions can occur to reach a destination location. By way of example, the user may swipe multiple times and/or in multiple directions, select different folders, navigate menu options, and so forth. So long as the first input to pick-up the object 602 is continued during such a multi-step navigation, the object 602 continues to appear within the viewing pane. Once an appropriate destination location is reached, the user can release the object 602 to rearrange the object at the destination location by discontinuing the first input 310 as represented at “E”. For example, the user may pull their hand or finger off of the touchscreen to conclude the “press and hold” gesture. The object 602 is now rearranged within the navigable content at the selected destination location. When the object is dropped, the object can automatically be rearranged within content at the destination location without a user selecting a precise location within the content. Additionally or alternatively, a user may select a precise location for the object by dragging the object to an appropriate position in the viewing pane 302 before releasing the object. Thus, if the picked-up object is positioned between two particular objects at the destination location, the object when dropped may be rearranged between the two particular objects.

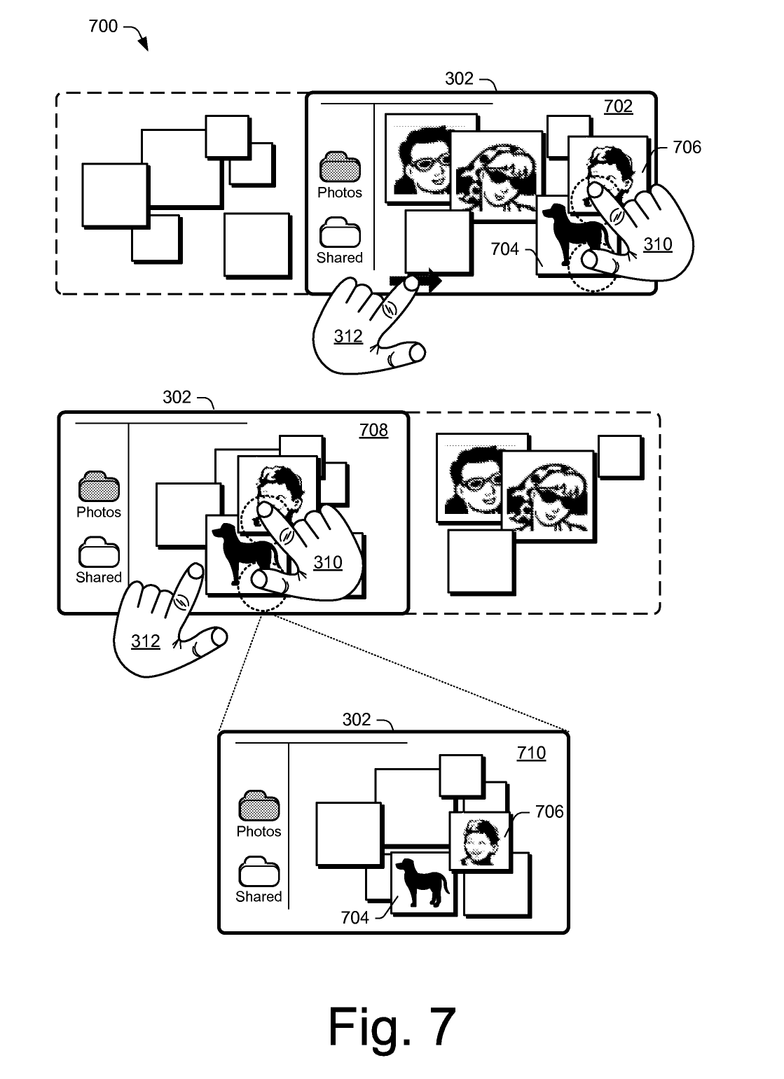

FIG. 7 illustrates yet another rearrangement example in accordance with one or more embodiments, generally at 700. This example is similar to the example of FIG. 4 except here a multi-input rearrange is applied to rearrange multiple objects. A viewing pane 302 is depicted as providing a view 702 of content, which for this example is again a photo collection. First input 310 is used to select objects 704 and 706, which are represented as photos within the photo collection. In this case, the objects are shown as being selected by a multi-touch input applied using different fingers of the same hand to select different objects. In another approach many different objects can be selected by touching and holding one object with a finger and tapping other objects with other fingers to add the object to a selected group. Other suitable selection techniques, such as a lasso gesture to bundle objects, dragging of a selection box, toggling objects in a selection mode, and other selection tools can also be used to create a selected group of objects. The selected group may then be rearranged together.

Second input 312, such as a swiping gesture and/or other navigation actions, can be applied to navigate content and select a destination location for objects 704, 706 as discussed previously. For instance, the view 708 shows navigation of the viewing pane 302 to a different location within content (e.g., the left side in FIG. 7) in response to the second input 312. The objects may be released at the selected location upon concluding the first input, such as by lifting fingers holding the objects or otherwise. When released, the objects are dropped at the new location and can be rearranged with other objects appearing at the destination. A rearranged view 710 is depicted that represents the rearrangement of the multiple objects 704, 706 at the destination position.

Having described some example user interface and gestures for multi-input rearrange techniques, consider now a discussion of example multi-input rearrange methods in accordance with one or more embodiments.

Example Methods

The following section describes example methods for multi-input rearrange techniques in accordance with one or more embodiments. A variety of suitable combinations of gestures and/or input can be employed to pick-up objects and navigate to different locations within navigable content to rearrange objects, some examples of which have been described in the preceding discussion. As mentioned, the inputs can be different touch inputs including but not limited to input from different hands. Additional details regarding multi-input rearrange techniques are discussed in relation to the following example methods.

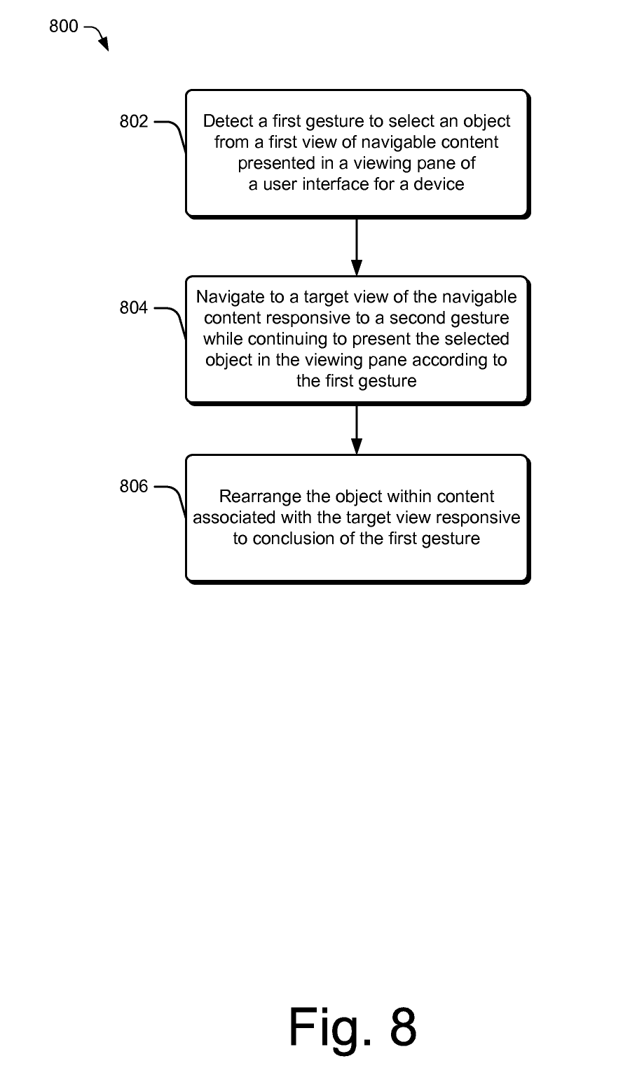

FIG. 8 is a flow diagram that describes steps of an example method 800 in accordance with one or more embodiments. The method can be performed in connection with any suitable hardware, software, firmware, or combination thereof. In at least some embodiments, the method can be performed by a suitably-configured computing device 102 having a gesture module 104, such as those described above and below.

Step 802 detects a first gesture to select an object from a first view of navigable content presented in a viewing pane of a user interface for a device. By way of example and not limitation, a user may press and hold an object, such as an icon representing a file, using a finger of one hand. The icon can be presented within a user interface for a computing device 102 that is configured to enable various interactions with content, device applications, and other functionality of the device. The user interface can be configured as an interface of an operating system, a file system, and/or other device application. Different views of content can be presented via the viewing pane through navigation actions such as panning, scrolling, menu selection, and so forth. Thus, the viewing pane enables a user to navigate, view, and interact with content and functionality of a device in various ways.

The user may select the object as just described to rearrange the object to a different location, such as to rearrange the object to a different folder or collection, share the object, add the object to sync folder, attach the object to a message, and so forth. Detection of the first gesture causes the object to remain visibly available within the viewing pane as the user rearranges to object to a selected location. In other words, the first gesture can be applied to pick-up the object and hold the object while performing other gestures or inputs to navigate content via the user interface.

In particular, step 804 navigates to a target view of the navigable content responsive to a second gesture while continuing to present the selected object in the viewing pane according to the first gesture. By way of example and not limitation, a user may perform a swiping gesture with one or more fingers of their other hand to pan or scroll the navigable content. In one approach the object is kept visually available within the viewing pane as other content passes through the viewing pane during navigation. The object can be kept visible by continued application of the first gesture to pick-up the object. This is so even though a location at which the object initially appears in the user interface may scroll outside of the viewing pane and become hidden due to the navigation.

Step 806 rearranges the object within content located at the target view responsive to conclusion of the first gesture. For instance, in the above example the user may release the press and hold applied to the object, which concludes the first gesture. Upon conclusion of the first gesture, the object can be rearranged with content at the selected location.

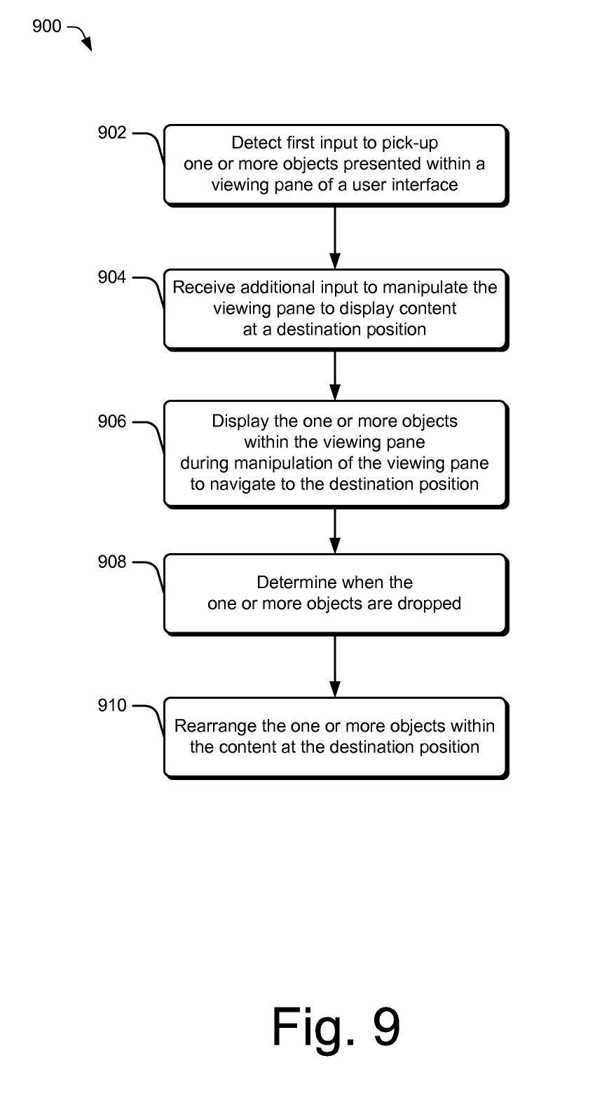

FIG. 9 is a flow diagram that describes steps of another example method 900 in accordance with one or more embodiments. The method can be performed in connection with any suitable hardware, software, firmware, or combination thereof. In at least some embodiments, the method can be performed by a suitably-configured computing device 102 having a gesture module 104, such as those described above and below.

Step 902 detects first input to pick-up one or more objects presented within a viewing pane of a user interface. Any suitable type of input action can be used to pick-up objects, some examples of which have been provided herein. Once an object has been picked-up, the object may remain visibly displayed on the touchscreen display until the object is dropped. This enables a user to rearrange the objects to a different location in a manner comparable to picking-up and moving of a physical object.

Step 904 receives additional input to manipulate the viewing pane to display content at a destination position. For example, various navigation related input such as gestures to navigate content through the viewing pane can be received. The additional input can also include menu selections, file system navigations, launching of different applications, and other input to navigate to a selected destination location. To provide the additional input, the user maintains the first input and uses a different hand, gesture and/or other suitable input mechanism for the additional input to navigate to a destination location. In one particular example, a user selects objects using touch input applied to a touchscreen from one hand and then navigates content using touch input applied to the touchscreen from another hand.

As long as the first input to pick-up the objects is maintained, step 906 displays the one or more objects within the viewing pane during manipulation of the viewing pane to navigate to the destination position. Step 908 determines when the one or more objects are dropped. For instance, a user can drop the objects by releasing the first input in some way. When this occurs, the conclusion of the first input can be detected via the gesture module 104. In the case of direct selection by a finger or stylus, the user may lift their finger or the stylus to release a picked-up object. If a mouse or other input device is used, the release may involve releasing a button of the input device. When the picked-up objects are dropped, Step 910 rearranges the one or more objects within the content at the destination position. The one or more objects may be rearranged in various ways and the rearrangement may be animated in some manner as previously discussed.

Having described some example multi-input rearrange techniques, consider now an example device that can be utilized to implement one more embodiments described above.

Example Device

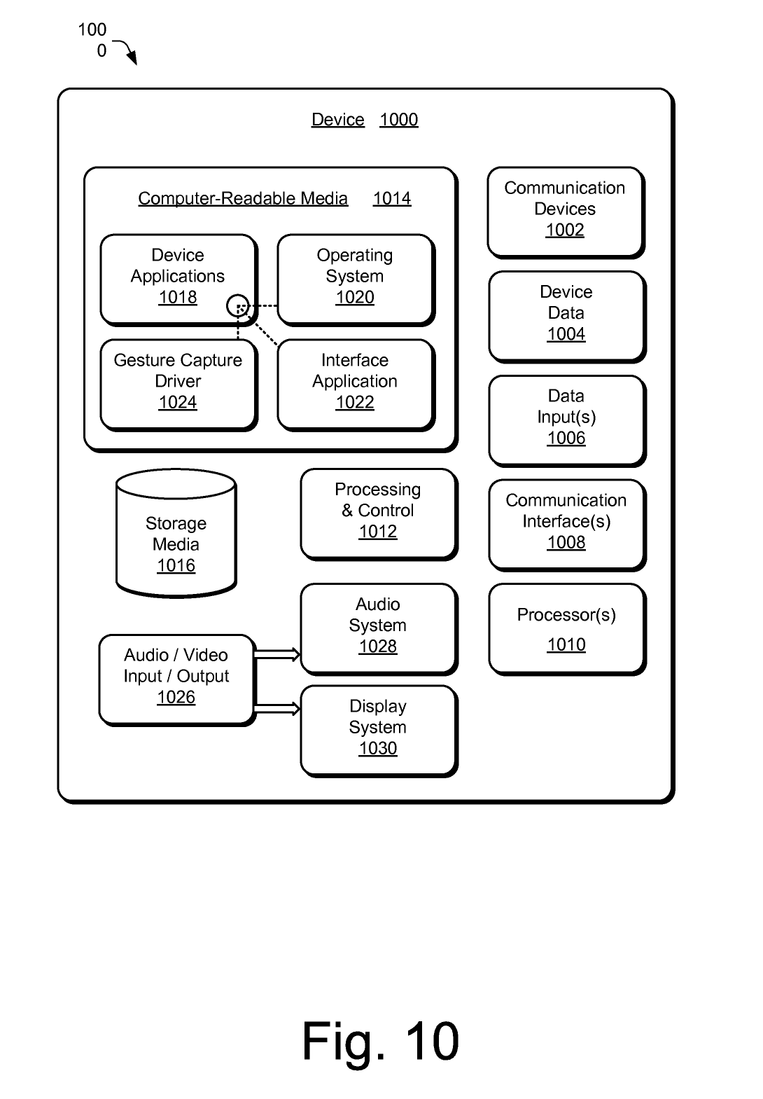

FIG. 10 illustrates various components of an example device 1000 that can be implemented as any type of portable and/or computing device as described with reference to FIGS. 1 and 2 to implement embodiments of the multi-input rearrange techniques described herein. The device 1000 includes communication devices 1002 that enable wired and/or wireless communication of device data 1004 (e.g., received data, data that is being received, data scheduled for broadcast, data packets of the data, etc.). The device data 1004 or other device content can include configuration settings of the device, media content stored on the device, and/or information associated with a user of the device. Media content stored on device 1000 can include any type of audio, video, and/or image data. Device 1000 includes one or more data inputs 1006 via which any type of data, media content, and/or inputs can be received, such as user-selectable inputs, messages, music, television media content, recorded video content, and any other type of audio, video, and/or image data received from any content and/or data source.

Device 1000 also includes communication interfaces 1008 that can be implemented as any one or more of a serial and/or parallel interface, a wireless interface, any type of network interface, a modem, and as any other type of communication interface. The communication interfaces 1008 provide a connection and/or communication links between device 1000 and a communication network by which other electronic, computing, and communication devices communicate data with device 1000.

Device 1000 includes one or more processors 1010 (e.g., any of microprocessors, controllers, and the like) which process various computer-executable or readable instructions to control the operation of device 1000 and to implement the gesture embodiments described above. Alternatively or in addition, device 1000 can be implemented with any one or combination of hardware, firmware, or fixed logic circuitry that is implemented in connection with processing and control circuits which are generally identified at 1012. Although not shown, device 1000 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1000 also includes computer-readable media 1014 that may be configured to maintain instructions that cause the device, and more particularly hardware of the device to perform operations. Thus, the instructions function to configure the hardware to perform the operations and in this way result in transformation of the hardware to perform functions. The instructions may be provided by the computer-readable media to a computing device through a variety of different configurations.

One such configuration of a computer-readable media is signal bearing media and thus is configured to transmit the instructions (e.g., as a carrier wave) to the hardware of the computing device, such as via a network. The computer-readable media may also be configured as computer-readable storage media that is not a signal bearing medium and therefore does not include signals per se. Computer-readable storage media for the device 1000 can include one or more memory devices/components, examples of which include fixed logic hardware devices, random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1000 can also include a mass storage media device 1016.

Computer-readable media 1014 provides data storage mechanisms to store the device data 1004, as well as various device applications 1018 and any other types of information and/or data related to operational aspects of device 1000. For example, an operating system 1020 can be maintained as a computer application with the computer-readable media 1014 and executed on processors 1010. The device applications 1018 can include a device manager (e.g., a control application, software application, signal processing and control module, code that is native to a particular device, a hardware abstraction layer for a particular device, etc.). The device applications 1018 also include any system components or modules to implement embodiments of the techniques described herein. In this example, the device applications 1018 include an interface application 1022 and a gesture-capture driver 1024 that are shown as software modules and/or computer applications The gesture-capture driver 1024 is representative of software that is used to provide an interface with a device configured to capture a gesture, such as a touchscreen, track pad, camera, and so on. Alternatively or in addition, the interface application 1022 and the gesture-capture driver 1024 can be implemented as hardware, fixed logic device, software, firmware, or any combination thereof.

Device 1000 also includes an audio and/or video input-output system 1026 that provides audio data to an audio system 1028 and/or provides video data to a display system 1030. The audio system 1028 and/or the display system 1030 can include any devices that process, display, and/or otherwise render audio, video, and image data. Video signals and audio signals can be communicated from device 1000 to an audio device and/or to a display device via an RF (radio frequency) link, S-video link, composite video link, component video link, DVI (digital video interface), analog audio connection, or other similar communication link. In an embodiment, the audio system 1028 and/or the display system 1030 are implemented as external components to device 1000. Alternatively, the audio system 1028 and/or the display system 1030 are implemented as integrated components of example device 1000.

### CONCLUSION

Multi-input rearrange techniques have been described by which multiple inputs are used to rearrange items within navigable content of a computing device. In one approach, one hand can be used for a first gesture to pick-up an object and another hand can be used for gestures/input to navigate content while the picked-up object is being “held” by continued application of the first gesture. Objects that are picked-up remain visually available within a viewing pane as content is navigated through the viewing pane so long as the first input continues. Additional input to navigate content can be used to rearrange selected objects, such as by moving the object to a different file folder, attaching the objects to a message, and so forth.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A method implemented by a computing device comprising:
detecting first input to pick-up one or more objects presented within a viewing pane of a user interface for the computing device;
receiving additional input to manipulate the viewing pane to navigate content available via the computing device;
displaying the one or more objects within the viewing pane during manipulation of the viewing pane to navigate content.

2. The method of claim 1, wherein one or more objects are displayed within the viewing pane based upon continued application of the first input including when content locations in which the one or more objects initially appear become hidden due to the manipulation of the viewing pane.

3. The method of claim 1, further comprising:
determining when the one or more objects are dropped at a destination position; and
rearranging the one or more objects within content associated with the destination position.

4. The method of claim 1, wherein the first input and the additional input comprise a combination of one or more gestures applied to a touchscreen of the computing device and input provided via one or more input devices.

5. The method of claim 1, wherein the first input comprises a grasping gesture applied to representations of the one or more objects via a touchscreen of the computing device.

6. The method of claim 1, wherein the one or more objects comprise files arranged within a collection.

7. The method of claim 1, wherein the additional input comprises a swiping gesture applied to a touchscreen of the computing device.

8. The method of claim 1, wherein the first input and the additional input comprise gestures applied separately to a touchscreen of the computing device by different hands.

9. The method of claim 1, wherein the additional input to manipulate the viewing pane includes selection of a destination location within a collection of content to which the one or more objects are to be rearranged.

10. The method of claim 1, wherein the additional input to manipulate the viewing pane includes selection of a file system folder within which the one or more objects are to be rearranged.

11. One or more computer readable storage media storing computer readable instructions that, when executed by a computing device, implement a gesture module to perform operations comprising:
recognizing a first gesture applied to pick-up one or more objects presented within a viewing pane of a user interface for a computing device;
in response to the first gesture, causing the one or more objects to remain visually available within the viewing pane during navigation of content through the viewing pane to rearrange the one or more objects as long as the first gesture is applied;
detecting additional input to navigate to a destination location for the one or more objects;
in response to the additional input, navigating to the destination location while keeping the one or more objects visually available within the viewing pane;
determining when the first gesture is concluded to drop the one or more objects at the destination location; and
when the first gesture is concluded, rearranging the one or more objects within content at the destination location.

12. The one or more computer readable storage media of claim 11, wherein the first gesture is applied to a touchscreen of the computing device by one hand and the additional input includes a gesture applied to the touchscreen by another hand.

13. The one or more computer readable storage media of claim 11, wherein:
the first gesture is applied to representations of the one or more objects via a touchscreen of the computing device; and
the second input includes navigational input to scroll the content through viewing pane provided via an input device.

14. The one or more computer readable storage media of claim 11, wherein the first gesture is applied to pick-up multiple objects for rearrangement to the destination location as a group.

15. The one or more computer readable storage media of claim 11, wherein keeping the one or more objects visually available comprises connecting the one or more objects to the viewing pane in a visible position as different content passes through viewing pane to reach the destination location.

16. A computing device comprising:
one or more processors; and
one or more computer-readable storage media having instructions stored thereon that, when executed by the one or more processors, perform operations for rearrangement of an object including:
detecting a first gesture to select the object from a first view of navigable content presented in a viewing pane of a user interface for the computing device;
navigating to a target view of the navigable content responsive to a second gesture while continuing to present the selected object in the viewing pane according to the first gesture; and
rearranging the object within content associated with the target view responsive to conclusion of the first gesture.

17. The computing device of claim 16, wherein the operations for rearrangement of the object include detecting the first gesture and the second gesture as input applied to a touchscreen display coupled to the computing device upon which the user interface is presented.

18. The computing device m of claim 16, wherein:
the first gesture comprises pressing and holding a finger to the object on a touchscreen display upon which the user interface is presented; and
the first gesture is maintained during the navigating by continued contact of the finger to the object on the touchscreen as content presented within the viewing pane changes.

19. The computing device of claim 16, wherein the second gesture includes a swiping gesture applied to a touchscreen upon which the user interface is presented to cause different content to pass through the viewing pane.

20. The computing device of claim 16, wherein the second gesture includes one or more of panning, scrolling, a menu selection, or a folder selection to navigate to the target view.
